(19) United States
(12) Patent Application Publication
(10) Pub. No.: US 2024/0416544 A1
(43) Pub. Date: Dec. 19, 2024

(54) POLE PIECE CUTTING DEVICE

(71) Applicant: WUXI LEAD INTELLIGENT EQUIPMENT CO., LTD., Wuxi (CN)

(72) Inventors: JIAHONG YIN, Jiangsu (CN); Xiaofei Chen, Jiangsu (CN); Luhua Liu, Jiangsu (CN); Xiaowang Dai, Wuxi (CN); Fangxu Gong, Jiangsu (CN)

(73) Assignee: WUXI LEAD INTELLIGENT EQUIPMENT CO., LTD., Wuxi (CN)

(21) Appl. No.: 18/814,165

(22) Filed: Aug. 23, 2024

Related U.S. Application Data
(63) Continuation of application No. PCT/CN2019/129896, filed on Dec. 30, 2019.

(30) Foreign Application Priority Data
Jan. 2, 2019 (CN) 201920005984.0
Jun. 12, 2019 (CN) 201920885112.8

(51) Int. Cl. B26D 7/18

(52) U.S. Cl. CPC B26D 7/18

(57) ABSTRACT

Disclosed is a pole piece cutting device, comprising a pole piece conveying mechanism for conveying a pole piece, a pole piece cutting mechanism for cutting the pole piece and an adsorption mechanism for adsorbing a scrap material generated during cutting of the pole piece. The adsorption mechanism comprises a conveying belt provided with an adsorption hole for adsorbing the scrap material. With such an arrangement, it is possible to improve adsorption of the pole piece, reduce the jitter of the pole piece, thereby increasing the accuracy of cutting the pole piece.

### CROSS-REFERENCE TO RELATED APPLICATIONS

This application is a continuation-in-part of International Application No. PCT/CN2019/129896 filed on Dec. 30, 2019, which claims priority to Chinese Patent Application No. 201920005984.0 filed on Jan. 2, 2019, and to Chinese Patent Application No. 201920885112.8 filed on Jun. 12, 2019, all of which are hereby incorporated by reference in their entireties.

### TECHNICAL FIELD

The present disclosure relates to a pole piece cutting device, which relates to the field of lithium battery automation equipment.

### BACKGROUND

During processing of tabs through laser die-cutting, since there are still a part of the cut-off scrap material connected to the processed pole pieces, the cut-off scrap material will cause the processed pole pieces to jitter under the influences of factors such as the weight of the scrap material. The jitter of the pole piece exerts influence on laser cutting positions, thereby influencing the accuracy of cutting the tab.

In the prior art, there has been a technical solution for solving the jitter problem of the pole piece by adopting an adsorption roller to adsorb the scrap material. However, the solution of adopting the adsorption roller to adsorb the scrap material has the following problems: (1) the adsorption region is relatively small, resulting in insufficient adsorption force; (2) in order to enlarge the adsorption region, it is necessary to design an adsorption roller of a larger diameter, and thus the adsorption roller is not able to reliably adsorb the scrap material at an initial stage of forming the scrap material; (3) due to rotational inertia of the adsorption roller, it is prone to causing the adsorbed scrap material to generate a pulling force on the pole piece, which is prone to causing the pole piece to jitter.

### SUMMARY

An objective of the present disclosure is to provide a pole piece cutting device which may reduce the jitter of the pole piece and increase the accuracy of cutting the pole piece.

In order to achieve the above objective, the present disclosure adopts the following technical solution: a pole piece cutting device, comprising: a pole piece conveying mechanism for conveying a pole piece, a pole piece cutting mechanism for cutting the pole piece and an adsorption mechanism for adsorbing a scrap material generated during cutting of the pole piece, wherein the adsorption mechanism comprises a conveying belt provided with an adsorption hole for adsorbing the scrap material.

As a further improved technical solution of the present disclosure, the adsorption mechanism comprises a drive roller, a first driven roller, a second driven roller and an actuator for driving the drive roller to rotate, and the conveying belt is sleeved on the drive roller, the first driven roller and the second driven roller.

As a further improved technical solution of the present disclosure, the first driven roller and the second driven roller are located at one end of the adsorption mechanism, and the drive roller is located at the other end of the adsorption mechanism; each of the first driven roller and the second driven roller has a diameter smaller than that of the drive roller.

As a further improved technical solution of the present disclosure, the conveying belt comprises an adsorption region located between the first driven roller and the second driven roller, the adsorption region being provided with the adsorption hole; the adsorption mechanism further comprises a mounting seat which is hollowed out and in communication with a piece of vacuum equipment, and the adsorption hole is in communication with the mounting seat.

As a further improved technical solution of the present disclosure, the first driven roller and the second driven roller are provided in alignment along a conveying direction of the pole piece, and the pole piece cutting device comprises a blowing mechanism for blowing gas to an outer surface of the second driven roller.

As a further improved technical solution of the present disclosure, the pole piece cutting device further comprises a first restraining component and a second restraining component for restraining the pole piece before cutting of the pole piece, the first restraining component and the second restraining component being respectively provided on two sides of the pole piece in a thickness direction of the same.

As a further improved technical solution of the present disclosure, the pole piece cutting device is provided with a first blowing hole and a second blowing hole, which are both used for connection to a blowing mechanism, wherein the first blowing hole and the second blowing hole each has a blowing direction parallel to a conveying direction of the pole piece, and the first blowing hole and the second blowing hole are respectively located at two sides of the pole piece in a thickness direction of the same.

As a further improved technical solution of the present disclosure, the pole piece cutting device comprises a dust collecting mechanism for removing dust from an outer surface of the conveying belt.

As a further improved technical solution of the present disclosure, the pole piece cutting device further comprises a cutting hood, inside which a cutting region of the pole piece is provided.

As a further improved technical solution of the present disclosure, one side of the cutting hood is connected to a blowing device, the other side of the cutting hood is connected to a dust extracting device, airflow generated by the blowing device is in a direction parallel to a surface of the pole piece and perpendicular to a conveying direction of the pole piece, the blowing device is used for blowing dust on the surface of the pole piece, and the dust extracting device is used for collecting dust generated by cutting the pole piece.

Compared with the prior art, the adsorption mechanism of the present disclosure comprises a conveying belt provided with the adsorption hole for adsorbing the scrap material; with this arrangement, it is possible to improve adsorption the pole piece, reduce the jitter of the pole piece, and thus increase the accuracy of cutting the pole piece.

### BRIEF DESCRIPTION OF THE DRAWINGS

FIG. 1 is a schematic diagram of an embodiment of a pole piece cutting device of the present disclosure;

FIG. 2 is a top view with some components in FIG. 1 removed;

FIG. 3 is a side view of an adsorption mechanism with the conveying belt in FIG. 1 removed;

FIG. 4 is a top view of the adsorption mechanism in FIG. 1;

FIG. 5 is a schematic diagram of the pole piece before and after cutting thereof;

FIG. 6 is a schematic diagram of a first restraining component and a second restraining component in another embodiment;

FIG. 7 is a structural schematic diagram of an embodiment of a tab forming device of the present disclosure;

FIG. 8 is a structural schematic diagram of an embodiment of the pole piece supporting mechanism in FIG. 7;

FIG. 9 is a structural schematic diagram of another embodiment of the tab forming device of the present disclosure;

FIG. 10 is a structural schematic diagram of yet another embodiment of the tab forming device of the present disclosure;

FIG. 11 is a front-view structural schematic diagram of an embodiment of an adsorption traction mechanism in FIG. 7;

FIG. 12 is a left-view structural schematic diagram of the adsorption traction mechanism in FIG. 7 with the belt and the actuator omitted;

FIG. 13 is a left-view structural schematic diagram of the adsorption traction mechanism in FIG. 7;

FIG. 14 is a structural schematic diagram of another embodiment of the adsorption traction mechanism in FIG. 7;

FIG. 15 is a structural schematic diagram of another embodiment of the tab forming device of the present disclosure.

### DETAILED DESCRIPTION

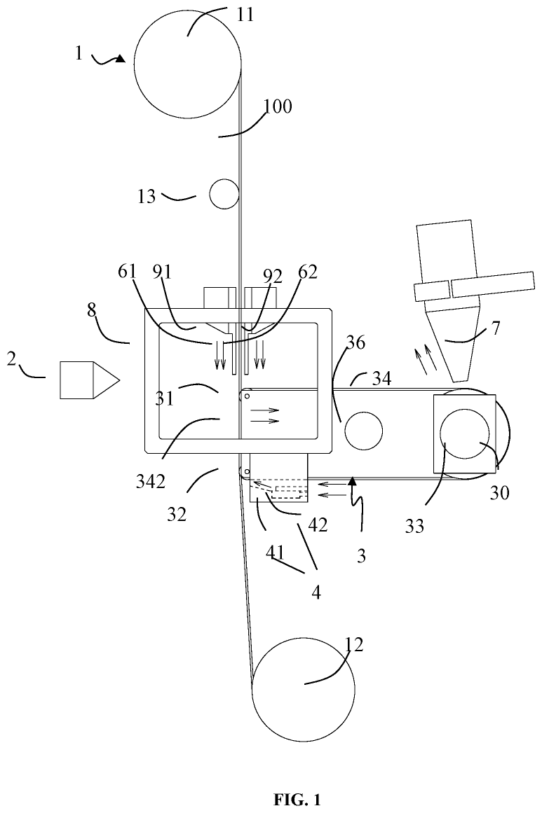

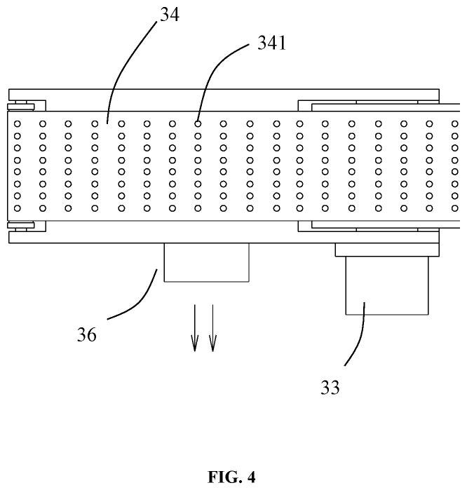

Please refer to FIGS. 1 to 6, the present disclosure proposes a pole piece cutting device, which mainly comprises a pole piece conveying mechanism 1 for conveying a pole piece 100, a pole piece cutting mechanism 2 for cutting the pole piece 100, and an adsorption mechanism 3 for adsorbing a scrap material generated during cutting of the pole piece 100.

In an embodiment shown in the present disclosure, the pole piece conveying mechanism 1 comprises a pole piece unwinding mechanism 11, a pole piece winding mechanism 12 and a guiding roller 13 located between the pole piece unwinding mechanism 11 and the pole piece winding mechanism 12, wherein the pole piece unwinding mechanism 11 is used for unwinding the pole piece 100 to be cut, the pole piece winding mechanism 12 is used for winding the pole piece 100 that has been cut to form the tab 102, and the guiding roller 13 is used for guiding the conveyance of the pole piece 100.

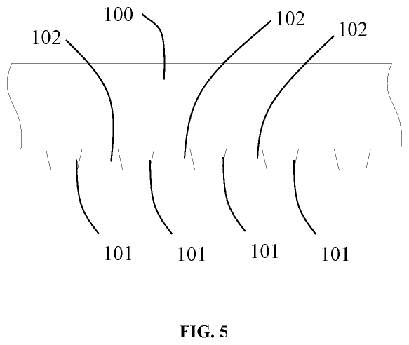

In an embodiment of the present disclosure, the pole piece cutting mechanism 2 comprises a laser for emitting laser light. Please refer to FIGS. 1 and 5, the laser light emitted by the laser is arranged opposite to the tab cutting region 101, finally achieving formation of the tab 102 in the tab cutting region 101; it is understood that scrap material may be generated in the process of the laser light cutting the pole piece 100 to form the tab 102.

In order to prevent the surface of the pole piece from jittering or bending due to the action of the scrap material on the pole piece 100 due to gravity, internal stress, etc. and influencing the quality of cutting the tab by the pole piece cutting mechanism 2, the adsorption mechanism 3 is provided at a position where the scrap material is generated, and is provided toward a position where the pole piece is cut, so as to adsorb the scrap material generated when the pole piece is cut. The adsorption mechanism 3 is used for providing an adsorption force to the scrap material generated in the process of forming the tab 102, so that the scrap material is adsorbed on the adsorption mechanism 3, so as to prevent the scrap material from causing the jitter of the pole piece 100 under the influence of factors such as its own weight and then from influencing accuracy of cutting the pole piece 100.

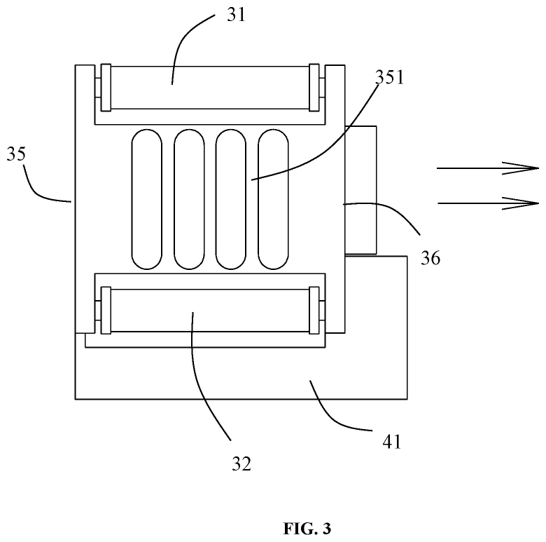

Specifically, in an embodiment shown in the present disclosure, the adsorption mechanism 3 comprises a first conveying roller 30, two second conveying rollers 31 and 32, an actuator 33 for driving the first conveying roller 30 or the second conveying roller to rotate, a conveying belt 34 sleeved on the first conveying roller 30 and the two second conveying rollers 31 and 32, a mounting seat 35 and a vacuum equipment 36. In one embodiment, the first conveying roller 30 is a drive roller 30, and the two second conveying rollers are respectively a first driven roller 31 and a second driven roller 32. The adsorption mechanism 3 comprises the drive roller 30, the first driven roller 31, the second driven roller 32, the actuator 33 for driving the drive roller 30 to rotate, the conveying belt 34 sleeved on the drive roller 30, the first driven roller 31 and the second driven roller 32, the mounting seat 35 (shown in FIG. 3) and the vacuum equipment 36. In an embodiment of the present disclosure, the conveying belt 34 is a belt, the mounting seat 35 is connected to the vacuum equipment 36 and is provided with an adsorption surface for adsorbing the scrap material. The adsorption surface is provided exactly opposite to the pole piece 100, and is provided opposite to the scrap material generated when the laser light cuts the pole piece 100 to form tab 102. The conveying belt 34 is provided with an adsorption portion, and when the adsorption portion of the conveying belt 34 passes over the adsorption surface of the mounting seat 35, may adsorb the scrap material generated when the laser light cuts the pole piece 100 onto the adsorption portion. Alternatively, the adsorption portion of the conveying belt 34 comprises several adsorption holes 341 for adsorbing the scrap material, and the adsorption holes 341 may be round holes, square holes, triangular holes, rectangular holes, irregularly shaped holes and so on, which is not limited in the present embodiment. The first driven roller 31 and the second driven roller 32 are located at one end of the adsorption mechanism 3, and the drive roller 30 is located at the other end of the adsorption mechanism 3. The first driven roller 31 and the second driven roller 32 are provided in alignment along the conveying direction of the pole piece 100.

In an embodiment shown in the present disclosure, the first driven roller 31 is an upper driven roller, and the second driven roller 32 is a lower driven roller. In one embodiment, the actuator 33 is a driving motor for driving the drive roller 30 to rotate and thus making the conveying belt 34 to perform conveying. In the present embodiment, a wider conveying belt 34 provided with several adsorption holes is provided and is connected to the first driven roller 31, the second driven roller 32 and the drive roller 30. Of course, a plurality of thinner conveying belts 34 may also be provided in parallel and side by side to connect with the first driven roller 31, the second driven roller 32 and the drive roller 30, and the specific implementation thereof is as follows: a plurality of grooves are provided at intervals along the axial direction of the drive roller 30, the first driven roller 31 and the second driven roller 32, where the grooves of the drive roller 30, the first driven roller 31, and the second driven roller 32 are in one-to-one correspondence, and the conveying belts 34 are respectively received in the grooves and are parallel to each other. When the drive roller 30 rotates, the plurality of conveying belts 34 synchronously drive the first driven roller 31 and the second driven roller 32 to rotate. In the present embodiment, there is no need to provide several adsorption holes 341 on the surface of the conveying belt 34, and since the conveying belt 34 between the first driven roller 31 and the second driven roller 32 is attached to or close to the adsorption surface of the mounting seat 35, gaps between the plurality of conveying belts 34 are provided opposite to the adsorption surface of the mounting seat 35, such that the pole piece 100 and the scrap material are adsorbed onto the surfaces of the plurality of conveying belts 34 through the gaps. In an embodiment of the present disclosure, the mounting seat 35 is hollowed out and in communication with the vacuum equipment 36. The conveying belt 34 between the first driven roller 31 and the second driven roller 32 forms an adsorption region 342, in which there is provided the adsorption holes 341. As shown in FIG. 3, the mounting seat 35 is provided with a plurality of air-extracting holes 351 in communication with the adsorption holes 341 at positions opposite to the scrap material of the cut pole piece 100. In an embodiment shown in the present disclosure, the air-extracting holes 351 are long strip-shaped waist holes; of course, in other embodiments, the air-extracting holes 351 may also be in other shapes such as circular holes, square holes, etc. The adsorption holes 341 may be in various shapes such as waist holes, round holes or square holes. After the scrap material is formed, the adsorption region 342 adsorbs and attaches the scrap material onto the conveying belt 34, and the scrap material continues to be conveyed along with the conveying belt 34. When the conveying speed of the scrap material is less than that of the pole piece 100, the scrap material may rub against the conveying belt 34, which causes problems such as wrinkling of the pole piece 100, and thus it should be ensured that the conveying speed of the scrap material coincides with the conveying speed of the pole piece 100 or is slightly faster than that of the pole piece 100. Since the adsorption region is a flat surface, when the scrap material is separated from the adsorption plane, it will fall to the set position under the action of its own gravity. In an embodiment shown in the present disclosure, each of the first driven roller 31 and the second driven rollers 32 has a diameter smaller than that of the drive roller 30, and the adsorption region 342 is located between the first driven roller 31 and the second driven rollers 32. When the distances between a rotation center of the first driven roller 31 and rotation centers of the second driven rollers 32 are the same, the smaller the diameters of the first driven roller 31 and the second driven roller 32 are, the larger the adsorption region 342 will be.

In the present embodiment, the diameters of the first driven roller 31 and the second driven roller 32 are designed according to the area of the adsorption region 342 required for actual production processing, so as to ensure a greater adsorption force on the scrap material and thus maintain a relatively large adsorption region 342, which increases the adsorption force, improves adsorption stability, and reduces the jittering issue of the pole piece 100 when cutting the tab 102.

The pole piece 100 and the scrap material are conveyed through the first driven roller 31 and the second driven roller 32 in turn. In order to prevent the scrap material from being continuously adsorbed and being continuously conveyed along the surface of the conveying belt 34 after passing through the second driven roller 32, the present disclosure provides a blowing mechanism 4 on the outer side of the second driven roller 32 for blowing gas to the outer surface of the second driven roller 32. The blowing mechanism 4 comprises a blowing base 41, inside which an airflow passage 42 and a blowing equipment (not shown) in communication to the airflow passage 42 are provided. Preferably, the blowing base 41 is fixedly provided on the lower surface of the mounting seat 35 so as to facilitate the arrangement.

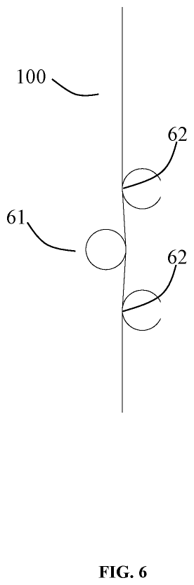

To better reduce the jitter of the pole piece 100 and thus increase the accuracy of cutting the tab 102, the present disclosure is provided with a first restraining component 61 and a second restraining component 62 for restraining the pole piece 100 before the pole piece 100 is cut, which are respectively provided at two sides in the thickness direction of the pole piece 100. With this arrangement, the first restraining component 61 and the second restraining component 62 are provided before the tab 102 is cut, such that the position of the pole piece 100 is restrained between the first restraining component 61 and the second restraining component 62, which reduces the jitter range of the pole piece 100 and increases the accuracy of cutting the tab 102. As shown in FIG. 1, in an embodiment, the first restraining component 61 and the second restraining component 62 are respectively a first pole piece restraining plate and a second pole piece restraining plate; as shown in FIG. 6, in other embodiments, the first restraining component 61 and the second restraining component 62 may also be replaced with at least one wheel. Preferably, adjacent two wheels are respectively provided at two sides in the thickness direction of the pole piece 100, so as to tension the pole piece 100.

As shown in FIG. 1, to prevent dust and the like generated by cutting the tabs 102 from being adsorbed on the surface, a dust collecting mechanism 7 is provided on the outer side of the surface of the conveying belt 34, and is used for adsorbing dust and the like on the surface of the conveying belt 34. In an embodiment of the present disclosure, the dust collecting mechanism 7 uses a dust collector or a brush, so as to brush the surface of the conveying belt 34 before using the dust collector to suck the dust.

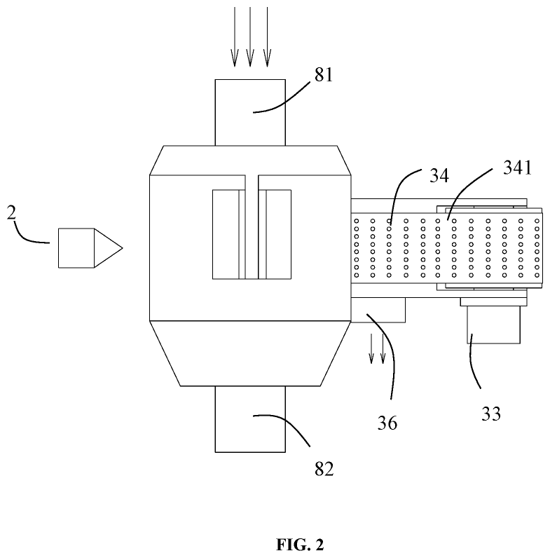

In order to collect the dust generated by cutting the tab 102, in the embodiment shown in the present disclosure, the pole piece cutting device further comprises a cutting hood 8, inside which a cutting region of the pole piece 100 is provided. As shown in FIG. 2, one side of the cutting hood 8 is connected to a blowing device 81, the other side of the cutting hood 8 is connected to a dust extracting device 82, wherein airflow generated by the blowing device 81 is in a direction parallel to a surface of the pole piece 100 and perpendicular to a conveying direction of the pole piece 100. The blowing device 81 is used for blowing the dust and other impurities on the surface of the pole piece 100, and the dust extracting device 82 is used for collecting the dust and other impurities generated by cutting the pole piece 100. With this arrangement, the pole piece cutting device of the present disclosure is fully located in the cutting hood 8, and the airflow flows concentratedly in the cutting hood 8, thereby achieving a better dust removal effect.

In order to further collect the dust generated by cutting the tab 102, the pole piece cutting device is provided with a first blowing hole 91 and a second blowing hole 92, which are both used for connection with the blowing mechanism (not shown), wherein blowing directions of the first blowing hole 91 and the second blowing hole 92 are parallel to a conveying direction of the pole piece 100, and the first blowing hole 91 and the second blowing hole 92 are respectively located at two sides of the pole piece in a thickness direction of the same 100. In addition, blowing the gas on both sides of the pole piece 100 may enable the gas velocities and the gas flow rates on both sides of the pole piece 100 to be the same, and thus the pole piece 100 may be prevented from jitter, and can blow off impurities such as dust on the surface of the pole piece 100. Preferably, the first blowing hole 91 and the second blowing hole 92 are respectively provided on the first restraining component 61 and the second restraining component 62. The first restraining component 61 or the second restraining component 62 may be connected to a cylinder (not shown), which facilitates quick adjustment of the spacing between the first restraining component 61 and the second restraining component 62, and facilitates passing through by the pole piece 100.

Of course, both the first restraining component 61 and the second restraining component 62 may be configured as a split structure, which specifically comprises a clamping plate and a gas knife. A die cavity is provided inside the gas knife and is externally connected to a blowing system. The gas knife is fixedly connected to the clamping plate, and a gap for forming the blowing hole is left between the lower side of the gas knife and the clamping plate.

### The Second Embodiment

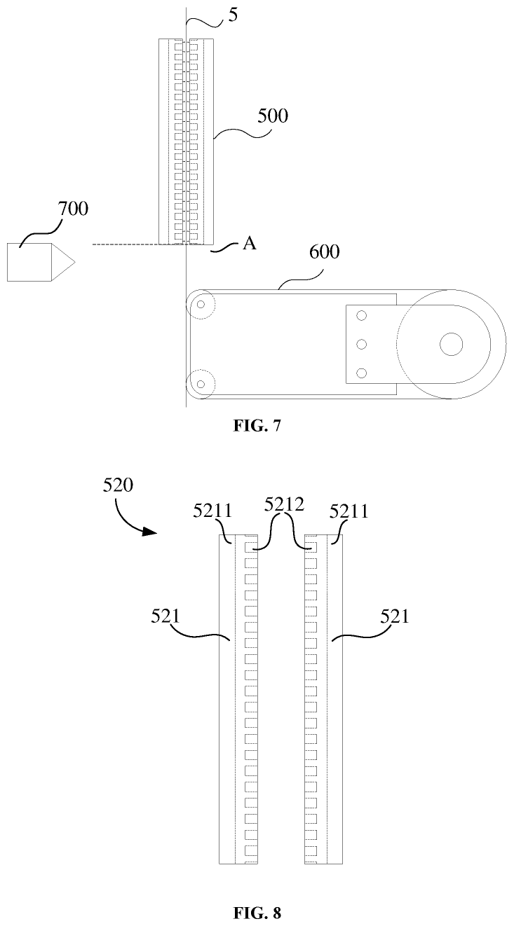

Another embodiment provided by the present disclosure is as follows: please refer to FIG. 7, FIG. 7 is a structural schematic diagram of an embodiment of a tab forming device of the present disclosure, which may specifically comprise a pole piece supporting mechanism 500, an adsorption mechanism 600 and a pole piece cutting mechanism 700. Wherein, the pole piece supporting mechanism 500 extends along the traveling direction of the pole piece 5 for supporting thereof. In one implementation scenario, the pole piece supporting mechanism 500 is a plate-shaped supporting mechanism, the extending direction of which being consistent with the traveling direction of the pole piece 5. For example, in order to simplify the structure of the pole piece supporting mechanism 500, the pole piece supporting mechanism 500 may comprise two opposite supporting plates, and there is a gap between the two opposite supporting plates for the pole piece 5 to pass through. It should be noted that, in order to ensure the support for the pole piece 5, the gap between the two opposite supporting plates is extremely narrow, only slightly greater than the thickness of the pole piece 5. The exact size of the gap may be set specifically according to the thickness of the desired defined pole piece, which is not limited in the present embodiment. Therefore, the jitter of the pole piece 5 is limited by the two opposite supporting plates, and the jitter amplitude of the pole piece 5 will not exceed the error range. In another implementation scenario, the pole piece supporting mechanism 500 is a roller supporting mechanism, which comprises at least one supporting roll and at least one tensioning roller. The pole piece 5 passes between the supporting roller and the tensioning roller. Unlike the supporting plate structure, the roller supporting mechanism clamps the pole piece 5 by means of cooperating supporting roller and tensioning roller, which defines the traveling position of pole piece 5. Therefore, when the pole piece 5 is jittering, the jittering cannot be conducted upstream or downstream through the supporting roller and the tensioning roller.

The adsorption mechanism 600 is provided at a discharge end A of the pole piece supporting mechanism 500, and adsorbs the pole piece 5 passing over the adsorption mechanism 600, such that the pole piece 5 is tensioned between the pole piece supporting mechanism 500 and the adsorption mechanism 600. The pole piece cutting mechanism 700 is provided between the pole piece supporting mechanism 500 and the adsorption mechanism 600, so as to cut out the tab on the passing pole piece 5. In one implementation scenario, the pole piece cutting mechanism 700 is a laser cutting device. In another implementation scenario, by reducing the reserved cutting position between the pole piece supporting mechanism 500 and the adsorption mechanism 600, that is, by narrowing the distance between the pole piece supporting mechanism 500 and the adsorption mechanism 600, it is possible to reduce the jitter of the pole piece 5, which is conducive to improving the cutting accuracy, and at the same time, facilitates the movement of the pole piece 5, from which the tab has been cut off, onto the adsorption mechanism 600 and moving to the downstream device via the adsorption mechanism 600.

In the above solution, by providing the pole piece cutting mechanism 700 between the pole piece supporting mechanism 500 and the adsorption mechanism 600, the pole piece 5 is supported by the pole piece supporting mechanism 500 extending along the traveling direction of the pole piece 5. By adsorbing the pole piece passing over the adsorption mechanism 600 with the adsorption mechanism 600 provided at the discharge end A of the pole piece supporting mechanism 500 such that the pole piece 5 between the pole piece supporting mechanism 500 and the adsorption mechanism 600 is tensioned, it is possible to improve the cutting effect of cutting out the tab on the pole piece 5 by the pole piece cutting mechanism 700.

In a specific implementation, the pole piece supporting mechanism 500 may further comprise an air pressure supporting mechanism in addition to the plate-shaped supporting mechanism and the roller supporting mechanism in the above embodiment, such as a positive pressure supporting mechanism 520 and a negative pressure supporting mechanism 530. The positive pressure supporting mechanism 520 and the negative pressure supporting mechanism 530 will be described respectively in detail below by way of examples.

Please refer to FIGS. 7 and 8, FIG. 8 is a structural schematic diagram of an embodiment of the pole piece supporting mechanism 500 in FIG. 7. In the present embodiment, the pole piece supporting mechanism 500 comprises the positive pressure supporting mechanism 520, which comprises two opposite positive pressure components. As shown in FIG. 7, the pole piece 5 passes between two opposite positive pressure components 521, and each positive pressure component 521 applies a positive pressure to the passing pole piece 5, such that the pole piece 5 is clamped between the two opposite positive pressure components 521. Specifically, each positive pressure component 521 comprises a clamping plate 5211 and a plurality of gas outlets 5212 opened on the clamping plate 5211. The clamping plate 5211 is in communication with a gas supply equipment (not shown), and the gas output from the gas supply equipment is ejected through the gas outlets 5212 so as to apply the positive pressure to the passing pole piece 5. In one implementation scenario, the plurality of gas outlets 5212 are interconnected, such that when the gas outlets 5212 are connected to the gas supply equipment, the gas may be ejected through the gas outlets 5212 to apply the positive pressure to the passing pole piece 5, and thus, both sides of the pole piece 5 are clamped by two opposite air pressures, and specifically, the pole piece 5 is suspended between two clamping plates 5211. Since both sides of the pole piece 5 are restrained by the air, if the pole piece 5 jitters, the gas may “hold” the pole piece 5, which prevents the jittering from being conducted along the pole piece 5 to the upstream or downstream thereof, and thus reduces the jitter; meanwhile, since the gas is blown toward the pole piece 5, the positive pressure applied to the pole piece 5 does not hinder the progress of the pole piece 5, which is convenient for the pole piece cutting mechanism 700 to continuously cut the pole piece 5. In one implementation scenario, the gas outlets 5212 are cylindrical, conical, and so on. The gas outlets 5212 may be distributed in an array. In one implementation scenario, a plurality of groups of positive pressure supporting mechanism 520 may be sequentially arranged along the traveling direction of the pole piece 5 to support the pole piece 5.

In one implementation scenario, the pole piece supporting mechanism 500 comprises both the plate-shaped supporting mechanism and the positive pressure supporting mechanism 520. Specifically, the pole piece supporting mechanism 500 comprises a supporting plate and a clamping plate 5211 opened with gas outlets 5212, these two plates are provided opposite to each other, and the pole piece 5 passes between the two plates. The clamping plate 5211 opened with the gas outlets 5212 is in communication with the gas supply equipment, the gas supply equipment supplies gas to the clamping plate 5211, and the gas is blown out through the gas outlets 5212 and is blown toward the supporting plate, such that the pole piece 5 adheres to the supporting plate. Therefore, the gas blown toward the pole piece 5 and supporting plate restrain the pole piece 5 to avoid the jittering from being conducted along the pole piece 5 to its upstream or downstream, so as to control the jitter of the pole piece 5 and stabilize the pole piece 5.

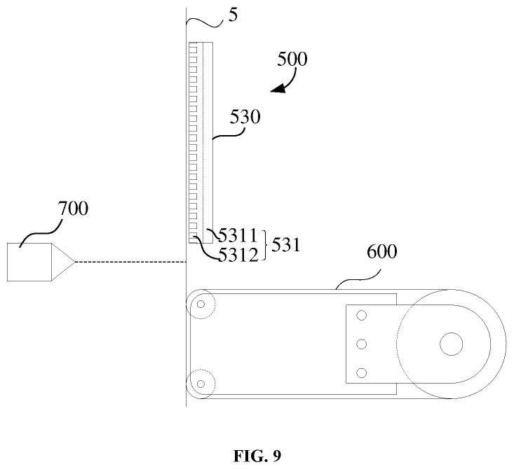

Please refer to FIG. 9, FIG. 9 is a structural schematic diagram of another embodiment of the tab forming device of the present disclosure. In the present embodiment, the pole piece supporting mechanism 500 comprises a negative pressure supporting mechanism 530, which comprises a negative pressure component 531. The negative pressure component 531 applies a negative pressure to the passing pole piece 5 so that the pole piece 5 is adsorbed onto the negative pressure component 531. Specifically, the negative pressure component 531 comprises a subplate 5311 and a plurality of suction holes 5312 opened on the subplate 5311. The subplate 5311 is in communication with an evacuating equipment (not shown), and the evacuating equipment evacuates the subplate 5311 to generate a negative pressure inside the subplate 5311, thereby applying a negative pressure to the passing pole piece 5 through the suction hole 5312. In one implementation scenario, the plurality of suction holes 5312 are interconnected, so that when the suction holes 5312 are connected to the evacuating equipment, the evacuating equipment evacuates the subplate 5311, such that a negative pressure is generated inside the subplate 5311, so as to apply the negative pressure to the passing pole piece 5 through the suction hole 5312, thereby adhering the pole piece 5 to the subplate 5311. Since the subplate 5311 has a certain adsorption force to the pole piece 5 through the negative pressure, the subplate 5311 may support the pole piece 5, so that the jitter cannot be conducted along the pole piece 5 to the upstream or downstream thereof, and by controlling the negative pressure, the traveling of pole piece 5 may refrain from being influenced. In one implementation scenario, the suction holes 5312 are cylindrical, conical, or the like, and may be distributed in an array. In one implementation scenario, a plurality of groups of negative pressure supporting mechanism 530 may be sequentially arranged along the traveling direction of the pole piece 5 to support the pole piece 5.

In one implementation scenario, the pole piece supporting mechanism 500 comprises both the plate-shaped supporting mechanism and the negative pressure supporting mechanism 530. Specifically, the pole piece supporting mechanism 500 comprises a supporting plate and a subplate 5311 opened with suction holes 5312, which are provided opposite to each other, and the pole piece 5 passes between the supporting plate and the subplate 5311. The subplate 5311 is in communication with an external evacuating equipment (not shown), and the evacuating equipment evacuates the subplate 5311, such that the pole piece 5 is attached to the subplate 5311. As a result, the subplate 5311 is attached to the pole piece 5, which may prevent jitter from being conducted to the upstream or downstream along the pole piece 5, thereby controlling the jitter of the pole piece 5 and stabilizing the pole piece 5. The supporting plate, which is provided on the other side of the pole piece 5, may protect the pole piece 5: if the pole piece 5 jitters or is accidentally separated from the subplate 5311, the pole piece 5 will also be restrained by the supporting plate, will not deviate too much from the subplate 5311, and may still be finally adsorbed by the subplate 5311.

Further, when the pole piece supporting mechanism 500 comprises two opposite plates (e.g., two clamping plates 5211, two subplates 5311, or a subplate 5311 and a supporting plate, or a clamping plate 5211 and a supporting plate, or two supporting plates), in order to ensure the stability of the pole piece 5, the distance between the two plates is not too large since the pole piece 5 passes between the two plates, otherwise they cannot function to restrain the position of the pole piece 5. Therefore, in order to facilitate the passing through of the pole piece 5, at least one plate is connected to an avoidance driving mechanism (not shown). The avoidance driving mechanism is connected to and drives the positive pressure component 521, the negative pressure component 531, or the supporting plate in the pole piece supporting mechanism 500, towards or away from the position where the pole piece 5 travels. When the avoidance driving mechanism drives the positive pressure component 521, the negative pressure component 531 or the supporting plate away from the position where the pole piece 5 travels, the pole piece 5 may pass through; and when the pole piece 5 arrives at the traveling position, the avoidance driving mechanism drives the positive pressure component 521, the negative pressure component 531 or the supporting plate towards the position where the pole piece 5 travels, so as to restrain the position of the pole piece 5. Specifically, the avoidance drive mechanism may drive the plate connected thereto away from the other plate provided opposite thereto to widen the distance between the two plates and to facilitate the passing through of the pole piece 5; further, after the pole piece 5 has passed through, the avoidance drive mechanism drives the plate connected thereto close to the other plate, so as to restrain the position of the pole piece 5. Specifically, the avoidance drive mechanism comprises an actuator, an output end of which being connected to the positive pressure component 521, or negative pressure component 531, or supporting plate in the pole piece supporting mechanism 500. Specifically, the clamping plate 5211 (or subplate 5311, or supporting plate) is provided at the output end of the actuator, with the actuator preferably being a cylinder. Further, the avoidance drive mechanism also comprises a guiding component, which is slidingly connected to the positive pressure component 521, or the negative pressure component 531, or the supporting plate in the pole piece supporting mechanism 500, and is provided facing toward the traveling position of the pole piece 5, that is, the guiding component is provided toward the position where the above “other plate” is located, thereby enabling the positive pressure component 521, or the negative pressure component 531, or the supporting plate to move under the driving of the actuator along the guiding component. In one implementation scenario, the guiding component is preferably a rail.

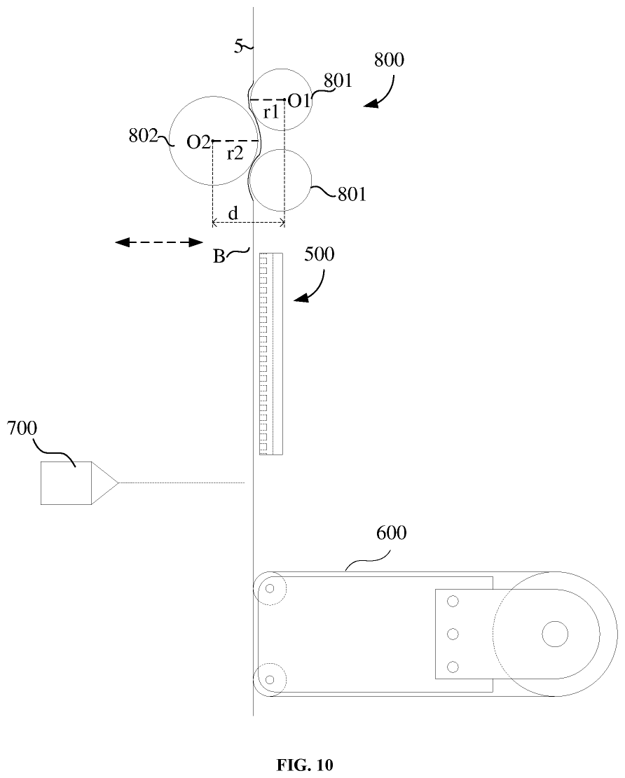

Please refer to FIG. 10, FIG. 10 is a structural schematic diagram of yet another embodiment of the tab forming device of the present disclosure. In the present embodiment, the tab forming device further comprises a guiding roller supporting mechanism 800, which cooperates with the adsorption mechanism 600 to achieve tensioning of the passing pole piece 5. Specifically, the guiding roller supporting mechanism 800 comprises at least one first guiding roller 801 and at least one second guiding roller 802, and the pole piece 5 passes between the first guiding roller 801 and the second guiding roller 802. The first guiding roller 801 and the second guiding roller 802 cooperate to clamp the pole piece 5, thereby restraining the position of the pole piece 5. At the same time, due to the inherent characteristics of the guiding rollers, the guiding roller drum moves along with them during traveling of the guiding rollers, without interfering with the traveling of the pole piece 5. As shown in FIG. 10, the guiding roller supporting mechanism 800 comprises two first guiding rollers 801 and one second guiding roller 802. In other implementation scenarios, to further cooperate with the adsorption mechanism 600 to tension the pole piece 5, the number of the first guiding roller 801 and the second guiding roller 802 may also be set to other values, such as one first guiding roller 801, one second guiding roller 802, or two first guiding rollers 801, two second guiding rollers 802, etc., which is not specifically limited in the present embodiment. In one implementation scenario, to ensure the supporting effect of the first guiding roller 801 and the second guiding roller 802 on the pole piece 5, the sum of the radius r1 of the first guiding roller 801 and the radius r2 of the second guiding roller 802 is greater than the distance d from the center O1 of the first guiding roller 801 to the center O2 of the second guiding roller 802 in a direction perpendicular to the traveling direction of the pole piece 5 (as indicated by the dashed arrow in the figure), such that the pole piece 5 has a certain wrap angle when passing around the first guiding roller 801 and the second guiding roller 802, thereby further ensuring the tensioning effect.

Please refer to FIG. 10, the guiding roller supporting mechanism 800 may also be provided at a feeding end B of the pole piece supporting mechanism 500. It should be noted that when the pole piece 5 passes around the guiding roller of the guiding roller supporting mechanism 800, the pole piece 5 does not completely envelop the guiding roller. At this time, the arc surface below the last guiding roller along the traveling direction of the pole piece 5 does not contact the pole piece 5, instead, it protrudes between the guiding roller supporting mechanism 800 and the adsorption mechanism 600. If the pole piece cutting mechanism 700 cuts the pole piece 5 between the guiding roller supporting mechanism 800 and the adsorption mechanism 600, in order to prevent the pole piece cutting mechanism 700 from cutting into the guiding roller, it is necessary not only to reserve a cutting distance between the guiding roller supporting mechanism 800 and the adsorption mechanism 600, but also to reserve a distance required for the part of the last guiding roller to protrude without contacting the pole piece 5. In other words, the distance between the guiding roller supporting mechanism 800 and the adsorption mechanism 600 will be extended beyond what is actually needed. The longer the distance, the larger part of the pole piece 5 will jitter, and the more likely it will be to influence the cutting. Thus, the pole piece supporting mechanism 500 is provided downstream of the guiding roller supporting mechanism 800, enabling the pole piece cutting mechanism 700 to cut the pole piece 5 between the pole piece supporting mechanism 500 and the adsorption mechanism 600. Since the pole piece supporting mechanism 500 is a plate-like structure and does not have excess arc surfaces similar to those of the guiding rollers, only the space required for cutting may be reserved between the pole piece supporting mechanism 500 and the adsorption mechanism 600, thereby ensuring the stability of the pole piece 5. At the same time, the tension force exerted on the pole piece 5 by the guiding roller supporting mechanism 800 is greater than the control force exerted on the pole piece 5 by the pole piece supporting mechanism 500, which allows for better control of the feeding state of the pole piece 5, further defines the position of the pole piece 5, and controls the jitter of the pole piece 5, thereby effectively stabilizing the pole piece 5.

In the embodiment of the tab forming device shown in FIG. 10, the pole piece supporting mechanism 500 is the negative pressure supporting mechanism 530. In one implementation scenario, the pole piece supporting mechanism 500 may also be the positive pressure supporting mechanism 520; in another implementation scenario, the pole piece supporting mechanism 500 may also be a plate-shaped supporting mechanism. In yet another implementation scenario, the pole piece supporting mechanism 500 may comprise a combination of any two or more of the positive pressure supporting mechanism 520, the negative pressure supporting mechanism 530, and the plate-shaped supporting mechanism, which is not specifically limited in the present embodiment, thereby achieving support for the pole piece 5 through the cooperation of the pole piece supporting mechanism 500 and the guiding roller supporting mechanism 800.

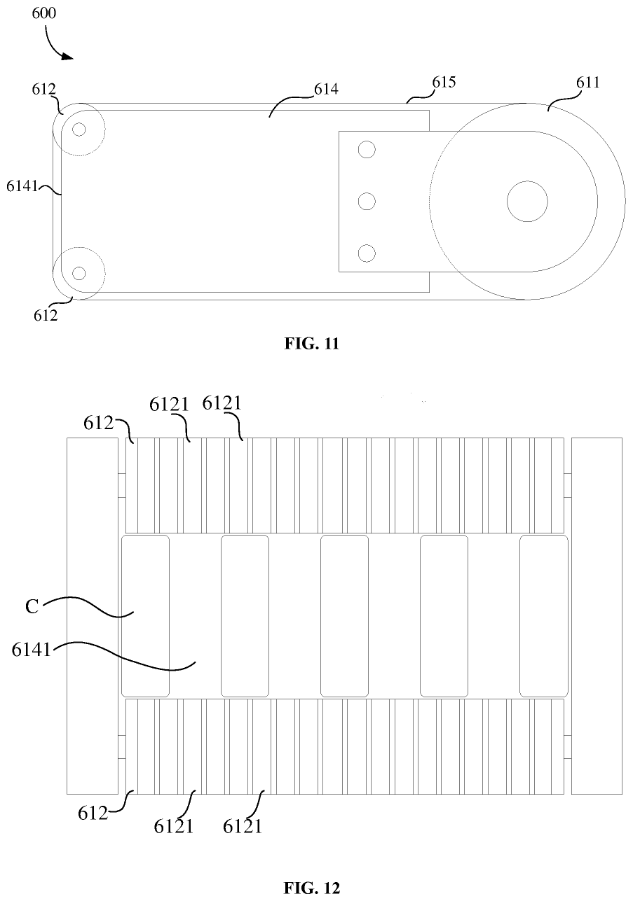

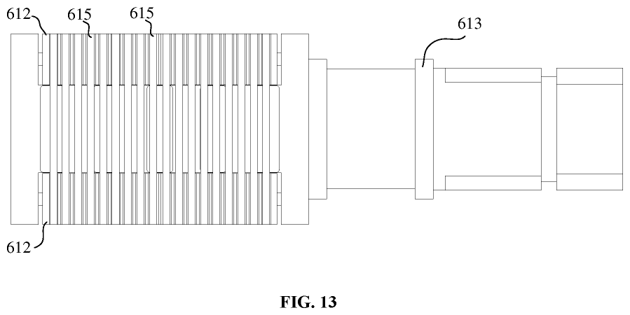

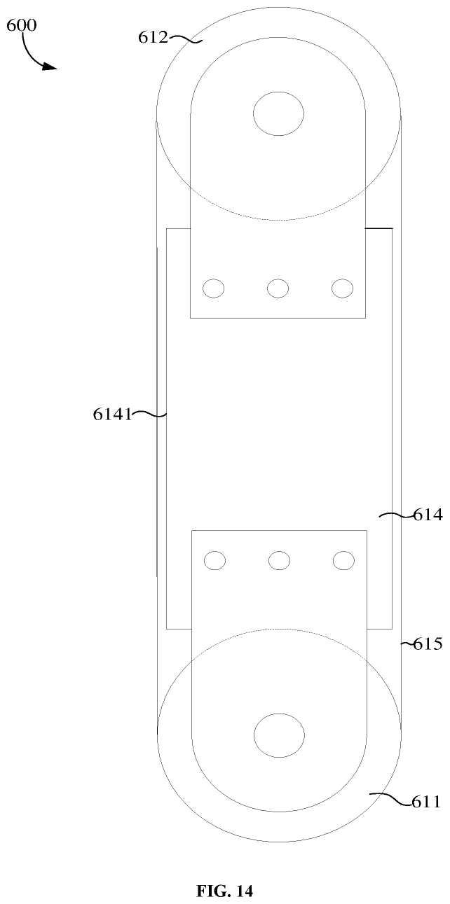

Please refer to FIG. 11, FIG. 11 is a front-view structural schematic diagram of an embodiment of an adsorption traction mechanism 600 in FIG. 7. Specifically, the adsorption mechanism 600 comprises a first conveying wheel 611, a second conveying wheel 612, an adsorption cavity 614 provided between the first conveying wheel 611 and the second conveying wheel 612, and a plurality of belts 615. The adsorption cavity 614 may also serve as a mounting base for mounting the second conveying wheel 612, which may have the same structure as the mounting seat 35 in the first embodiment. Please also refer to FIGS. 12 and 13, the belts 615 are sleeved over the first conveying wheel 611 and the second conveying wheel 612, and a plurality of notches 6121 are provided at intervals along the axial direction of the first conveying wheel 611 and the second conveying wheel 612, and are provided circumferentially around the wheel surfaces of the first conveying wheel 611 and the second conveying wheel 612. The belts 615 are accommodated within the notch 6121. Preferably, the notches on the first conveying wheel 611 and those on the second conveying wheel 612 are in one-to-one correspondence, and the plurality of belts 615 are respectively accommodated within all the notches 6121, and are parallel to each other. The adsorption cavity 614 has air-extracting holes C opened on an end 6141 close to the pole piece 5 and is in communication with the evacuating equipment. The evacuating equipment evacuates the adsorption cavity 614, so as to generate the negative pressure inside the adsorption cavity 614. The air-extracting holes C adsorb the pole piece 5 provided on the belts 615 through the gaps between the belts and are attached to the pole piece 5, that is, the adsorption cavity 614 forms the adsorption surface at the end 6141 close to the pole piece 5. Please continue to refer to FIG. 13, in one implementation scenario, the adsorption mechanism 600 may further comprise an actuator 613, which may be connected to the first conveying wheel 611, so as to drive the first conveying wheel 611, and further drive the second conveying wheel 612 through the belts 615, and thus achieve traction on the pole piece 5, such that the cut pole piece 5 is transported to the next workstation under the driving of the belts 615. By providing the plurality of belts 615 and accommodating each belt 615 within the corresponding notch 6121, it is possible to ensure the position of each belt 615 relatively fixed to make the conveying direction of the belts 615 relatively fixed, thereby ensuring the conveying stability and avoiding the deviation of the conveyed object from the preset position. Furthermore, if a belt 615 is damaged, it may be replaced individually without influencing other normal parts, thereby reducing maintenance costs.

In one implementation scenario, as shown in FIG. 11, the adsorption mechanism 600 may comprise two second conveying wheels 612, which are located on opposite sides of the ends 6141, so as to reduce the diameter of the second conveying wheels 612, and thus effectively shorten the time it takes for the pole piece 5 to reach the adsorption cavity 614 and be adsorbed by the adsorption cavity 614.

In one implementation scenario, the adsorption mechanism 600 may also employ an adsorption roller. The drum of the adsorption roller is provided with a plurality of air holes so as to communicate with the evacuating equipment (not shown) through these air holes, thereby adsorbing the passing pole piece 5. Furthermore, on the side of the adsorption roller facing toward the pole piece 5, there is a chamber inside that is in communication with the evacuating equipment. When the drum rotates to the chamber, the air holes may adsorb the pole piece 5. When the drum rotates to outside of the chamber, the pole piece 5 that is adsorbed on the current part of the drum will detach from the drum and be received by downstream equipment.

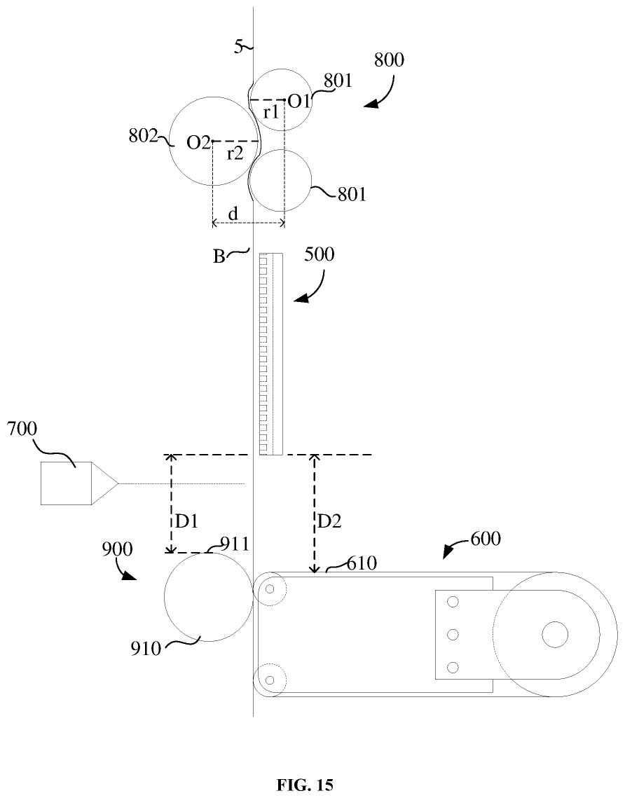

Please refer to FIG. 15, FIG. 15 is a structural schematic diagram of yet another embodiment of the tab forming device of the present disclosure. In the present embodiment, the tab forming device may further comprise an auxiliary mechanism 900. Specifically, the auxiliary mechanism 900 may be provided on the opposite side of the pole piece 5 relative to the adsorption mechanism 600, so as to prevent the pole piece from deviating from the adsorption mechanism 600 after being cut by the pole piece cutting mechanism 700. Since the auxiliary mechanism 900 is provided on the opposite side of the pole piece 5 relative to the adsorption mechanism 600, when the pole piece 5 deviates towards the side distal to the adsorption mechanism 600, it will be blocked by the auxiliary mechanism 900. To ensure the effectiveness of the auxiliary mechanism 900 in restraining the pole piece 5, the distance between the auxiliary mechanism 900 and the adsorption mechanism 600 may be slightly greater than the thickness of the pole piece 5. The specific distance is set according to the thickness of the pole piece to be produced, which is not limited in the present embodiment.

Preferably, the auxiliary mechanism 900 may comprise an auxiliary roller 910. An end face 911 of the auxiliary roller 910, which is close to the pole piece supporting mechanism 500, is at a first preset distance D1 from the pole piece supporting mechanism 500. An end face 610 of the adsorption mechanism 600, which is close to the pole piece supporting mechanism 500, is at a second preset distance D2 from the pole piece supporting mechanism 500. The first preset distance D1 is smaller than the second preset distance D2. In other words, the end face of the auxiliary roller 910 facing toward the pole piece supporting mechanism 500 protrudes beyond the end face of the adsorption mechanism 600 facing toward the pole piece supporting mechanism 500, and is closer to the pole piece cutting mechanism 700. At the same time, the pole piece cutting mechanism 700 is provided on the same side of the pole piece 5 as the auxiliary mechanism 900, and thus when the pole piece cutting mechanism 700 cuts the pole piece between the pole piece supporting mechanism 500 and the adsorption mechanism 600, the auxiliary roller 910 may protect the adsorption mechanism 600 to prevent it from being cut by the pole piece cutting mechanism 700.

The above embodiments are provided for illustrative purposes only and do not limit the technical solutions described in the present disclosure. The interpretation of this specification shall be based on those skilled in the art to which it belongs, e.g., directional descriptions such as “front,” “back,” “left,” “right,” “up,” and “down”. Although the present disclosure has been described in detail in this specification with reference to the above embodiments, those skilled in the art should understand that modifications or equivalent substitutions may still be made to the disclosure. Any technical solution and improvement thereof that does not depart from the spirit and scope of the present disclosure shall be included within the scope of the claims of the present disclosure.

1. A pole piece cutting device, comprising a pole piece conveying mechanism for conveying a pole piece, a pole piece cutting mechanism for cutting the pole piece and an adsorption mechanism for adsorbing a scrap material generated during cutting of the pole piece, wherein the adsorption mechanism comprises a conveying belt provided with an adsorption hole for adsorbing the scrap material.

2. The pole piece cutting device according to claim 1, wherein the adsorption mechanism comprises a drive roller, a first driven roller, a second driven roller and an actuator for driving the drive roller to rotate, and the conveying belt is sleeved on the drive roller, the first driven roller and the second driven roller.

3. The pole piece cutting device according to claim 2, wherein the first driven roller and the second driven roller are located at one end of the adsorption mechanism, and the drive roller is located at another end of the adsorption mechanism; each of the first driven roller and the second driven roller has a diameter smaller than that of the drive roller.

4. The pole piece cutting device according to claim 3, wherein the conveying belt comprises an adsorption region located between the first driven roller and the second driven roller, the adsorption region being provided with the adsorption hole; the adsorption mechanism further comprises a mounting seat which is hollowed out and in communication with a vacuum equipment, and the adsorption hole is in communication with the mounting seat.

5. The pole piece cutting device according to claim 2, wherein the first driven roller and the second driven roller are provided in alignment along a conveying direction of the pole piece, and the pole piece cutting device comprises a blowing mechanism for blowing gas to an outer surface of the second driven roller.

6. The pole piece cutting device according to claim 1, wherein the pole piece cutting device further comprises a first restraining component and a second restraining component for restraining the pole piece before cutting of the pole piece, the first restraining component and the second restraining component being respectively provided on two sides of the pole piece in a thickness direction of the pole piece.

7. The pole piece cutting device according to claim 1, wherein the pole piece cutting device is provided with a first blowing hole and a second blowing hole, which are both used for connection to a blowing mechanism, wherein the first blowing hole and the second blowing hole each has a blowing direction parallel to a conveying direction of the pole piece, and the first blowing hole and the second blowing hole are respectively located at two sides of the pole piece in a thickness direction of pole piece.

8. The pole piece cutting device according to claim 1, wherein the pole piece cutting device comprises a dust collecting mechanism for removing dust from an outer surface of the conveying belt.

9. The pole piece cutting device according to claim 1, wherein the pole piece cutting device further comprises a cutting hood, inside which a cutting region of the pole piece is provided.

10. The pole piece cutting device according to claim 9, wherein one side of the cutting hood is connected to a blowing device, another side of the cutting hood is connected to a dust extracting device, airflow generated by the blowing device is in a direction parallel to a surface of the pole piece and perpendicular to conveying direction of the pole piece, the blowing device is used for blowing dust on the surface of the pole piece, and the dust extracting device is used for collecting dust generated by cutting the pole piece.
